(19) United States
(12) Patent Application Publication
(10) Pub. No.: US 2025/0225002 A1
(43) Pub. Date: Jul. 10, 2025

(54) METHOD AND SYSTEM FOR MANAGING DISTRIBUTED EVENT PROCESSING

(71) Applicant: JPMorgan Chase Bank, N.A., New York, NY (US)

(72) Inventors: Pranav GANDHI, Bhayander (East) (IN); Anita MONDAL, Palghar (IN); Abhishek JAISWAL, Mumbai (IN)

(73) Assignee: JPMorgan Chase Bank, N.A., New York, NY (US)

(21) Appl. No.: 18/584,592

(22) Filed: Feb. 22, 2024

(30) Foreign Application Priority Data
Jan. 8, 2024 (IN) 202411001430

(51) Int. Cl. G06F 9/54

(52) U.S. Cl. CPC G06F 9/542; G06F 9/544; G06F 9/546

(57) ABSTRACT

A method for providing a management framework for distributed event processing is disclosed. The method includes retrieving data from a distributed event streaming platform based on a data fetch size configuration, the data including event messages; submitting a batch of the data to a consumer thread based on a data polling configuration; loading the batch of the data onto a data structure that enables coordination of processing threads, the data structure including a blocking queue; processing each of the event messages in the batch of the data from the data structure based on predefined logics; publishing each of the processed event messages in the batch of the data to a producer buffer based on a selection logic, the producer buffer including a load balancer; and recording an agreement for each of the published event messages in the batch of the data to a shared collection.

### CROSS-REFERENCE TO RELATED APPLICATIONS

This application claims the benefit of Indian Provisional Patent Application No. 202411001430, filed Jan. 8, 2024, which is hereby incorporated by reference in its entirety.

### BACKGROUND

### 1. Field of the Disclosure

This technology generally relates to methods and systems for distributed event processing, and more particularly to methods and systems for providing a management framework that facilitates improvements in distributed event processing by utilizing a unique multiple-consumers/multiple-producers design.

### 2. Background Information

Many business entities utilize complex data streaming platforms to facilitate operations and provide services for users. Often, to facilitate the operations and provide the services for the users, these complex data streaming platforms must manage and process vast quantities of event messages in limit amounts of time. Historically, implementations of conventional management frameworks for event message processing have resulted in varying degrees of success with respect to effective and efficient resource management for improved event message throughput and resiliency.

One drawback of implementing the conventional management frameworks is that in many instances, the data streaming platforms operate publisher-subscriber streaming models which only support a single consumer thread per topic partition. As a result, increasing partitions to support higher consumption throughput adds to infrastructure costs. Additionally, risk of event message loss in cases of infrastructure disruption is significantly increased when asynchronous publishing is used on the consumer thread to improve performance.

Therefore, there is a need for a management framework that facilitates improvements in event message processing by utilizing a unique configuration of multiple consumers and multiple producers to support high throughput, low latency event message streaming without event message loss and/or duplication.

### SUMMARY

The present disclosure, through one or more of its various aspects, embodiments, and/or specific features or sub-components, provides, inter alia, various systems, servers, devices, methods, media, programs, and platforms for providing a management framework that facilitates improvements in distributed event processing by utilizing a unique multiple-consumers/multiple-producers design.

According to an aspect of the present disclosure, a method for providing a management framework for distributed event processing is disclosed. The method is implemented by at least one processor. The method may include retrieving, via a client, data from a distributed event streaming platform based on a data fetch size configuration, the data may include at least one event message; submitting, via the client, a batch of the data to a consumer thread based on a data polling configuration; loading, via the consumer thread, the batch of the data onto a data structure that enables coordination of a plurality of processing threads, the data structure may include a blocking queue; processing, via at least one auxiliary consumer thread, each of the at least one event message in the batch of the data from the data structure based on at least one predefined logic; publishing, via the at least one auxiliary consumer thread, each of the processed at least one event message in the batch of the data to a producer buffer based on a selection logic, the producer buffer may include a load balancer; and recording, via the at least one auxiliary consumer thread, an agreement for each of the published at least one event message in the batch of the data to a shared collection.

In accordance with an exemplary embodiment, the method may further include flushing, via the producer buffer, each of the published at least one event message in the batch of the data to an event streaming broker based on at least one setting; determining, via the consumer thread, a completion status for each of the published at least one event message in the batch of the data based on the agreement; and committing, via the consumer thread, the batch of the data to the client based on the completion status and polling a new batch of the data.

In accordance with an exemplary embodiment, the data fetch size configuration may include a maximum fetch bytes value that is determined based on event message size to minimize a waiting threshold value for a batch processor, the waiting threshold value may relate to an amount of time.

In accordance with an exemplary embodiment, the data polling configuration may include a maximum size value for the batch of the data.

In accordance with an exemplary embodiment, to load the batch of the data onto the data structure, the method may further include monitoring, via the consumer thread, the data structure to determine whether the data structure is empty; and collecting, via the consumer thread, the agreement for each of the published at least one event message in the batch of the data when the data structure is empty based on a criterion, wherein the criterion may include at least one from among a predefined time value and a quantity value that corresponds to a number of the agreement that is equivalent in size to the batch of the data.

In accordance with an exemplary embodiment, each of the at least one auxiliary consumer thread may be predefined to asynchronously process each of the at least one event message in the batch of the data from the data structure.

In accordance with an exemplary embodiment, to process each of the at least one event message in the batch of the data from the data structure, the method may further include determining, via each of the at least one auxiliary consumer thread, that the corresponding at least one event message in the batch of the data is available in the data structure; removing, via each of the at least one auxiliary consumer thread, the corresponding at least one event message in the batch of the data from the data structure; and performing, via each of the at least one auxiliary consumer thread, the corresponding at least one predefined logic on the removed corresponding at least one event message.

In accordance with an exemplary embodiment, the agreement for each of the published at least one event message in the batch of the data may include a future callback that is invoked when an asynchronously sent record has been acknowledged as received.

In accordance with an exemplary embodiment, one from among a plurality of the data structure may be assigned to each of the at least one auxiliary consumer thread to preserve a processing order from an upstream topic.

According to an aspect of the present disclosure, a computing device configured to implement an execution of a method for providing a management framework for distributed event processing is disclosed. The computing device including a processor; a memory; and a communication interface coupled to each of the processor and the memory, wherein the processor may be configured to retrieve, via a client, data from a distributed event streaming platform based on a data fetch size configuration, the data may include at least one event message; submit, via the client, a batch of the data to a consumer thread based on a data polling configuration; load, via the consumer thread, the batch of the data onto a data structure that enables coordination of a plurality of processing threads, the data structure may include a blocking queue; process, via at least one auxiliary consumer thread, each of the at least one event message in the batch of the data from the data structure based on at least one predefined logic; publish, via the at least one auxiliary consumer thread, each of the processed at least one event message in the batch of the data to a producer buffer based on a selection logic, the producer buffer may include a load balancer; and record, via the at least one auxiliary consumer thread, an agreement for each of the published at least one event message in the batch of the data to a shared collection.

In accordance with an exemplary embodiment, the processor may be further configured to flush, via the producer buffer, each of the published at least one event message in the batch of the data to an event streaming broker based on at least one setting; determine, via the consumer thread, a completion status for each of the published at least one event message in the batch of the data based on the agreement; and commit, via the consumer thread, the batch of the data to the client based on the completion status and polling a new batch of the data.

In accordance with an exemplary embodiment, the data fetch size configuration may include a maximum fetch bytes value that is determined based on event message size to minimize a waiting threshold value for a batch processor, the waiting threshold value may relate to an amount of time.

In accordance with an exemplary embodiment, the data polling configuration may include a maximum size value for the batch of the data.

In accordance with an exemplary embodiment, to load the batch of the data onto the data structure, the processor may be further configured to monitor, via the consumer thread, the data structure to determine whether the data structure is empty; and collect, via the consumer thread, the agreement for each of the published at least one event message in the batch of the data when the data structure is empty based on a criterion, wherein the criterion includes at least one from among a predefined time value and a quantity value that corresponds to a number of the agreement that is equivalent in size to the batch of the data.

In accordance with an exemplary embodiment, the processor may be further configured to predefine each of the at least one auxiliary consumer thread to asynchronously process each of the at least one event message in the batch of the data from the data structure.

In accordance with an exemplary embodiment, to process each of the at least one event message in the batch of the data from the data structure, the processor may be further configured to determine, via each of the at least one auxiliary consumer thread, that the corresponding at least one event message in the batch of the data is available in the data structure; remove, via each of the at least one auxiliary consumer thread, the corresponding at least one event message in the batch of the data from the data structure; and perform, via each of the at least one auxiliary consumer thread, the corresponding at least one predefined logic on the removed corresponding at least one event message.

In accordance with an exemplary embodiment, the agreement for each of the published at least one event message in the batch of the data may include a future callback that is invoked when an asynchronously sent record has been acknowledged as received.

In accordance with an exemplary embodiment, the processor may be further configured to assign one from among a plurality of the data structure to each of the at least one auxiliary consumer thread to preserve a processing order from an upstream topic.

According to an aspect of the present disclosure, a non-transitory computer readable storage medium storing instructions for providing a management framework for distributed event processing is disclosed. The storage medium including executable code which, when executed by a processor, may cause the processor to retrieve, via a client, data from a distributed event streaming platform based on a data fetch size configuration, the data may include at least one event message; submit, via the client, a batch of the data to a consumer thread based on a data polling configuration; load, via the consumer thread, the batch of the data onto a data structure that enables coordination of a plurality of processing threads, the data structure may include a blocking queue; process, via at least one auxiliary consumer thread, each of the at least one event message in the batch of the data from the data structure based on at least one predefined logic; publish, via the at least one auxiliary consumer thread, each of the processed at least one event message in the batch of the data to a producer buffer based on a selection logic, the producer buffer may include a load balancer; and record, via the at least one auxiliary consumer thread, an agreement for each of the published at least one event message in the batch of the data to a shared collection.

In accordance with an exemplary embodiment, when executed by the processor, the executable code may further cause the processor to flush, via the producer buffer, each of the published at least one event message in the batch of the data to an event streaming broker based on at least one setting; determine, via the consumer thread, a completion status for each of the published at least one event message in the batch of the data based on the agreement; and commit, via the consumer thread, the batch of the data to the client based on the completion status and polling a new batch of the data.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment.

FIG. 3 shows an exemplary system for implementing a method for providing a management framework that facilitates improvements in distributed event processing by utilizing a unique multiple-consumers/multiple-producers design.

FIG. 4 is a flowchart of an exemplary process for implementing a method for providing a management framework that facilitates improvements in distributed event processing by utilizing a unique multiple-consumers/multiple-producers design.

FIG. 5 is a flow diagram of an exemplary process for implementing a method for providing a management framework that facilitates improvements in distributed event processing by utilizing a unique multiple-consumers/multiple-producers design.

FIG. 6 is a flow diagram of an exemplary order processing preservation process for implementing a method for providing a management framework that facilitates improvements in distributed event processing by utilizing a unique multiple-consumers/multiple-producers design.

### DETAILED DESCRIPTION

Through one or more of its various aspects, embodiments and/or specific features or sub-components of the present disclosure are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

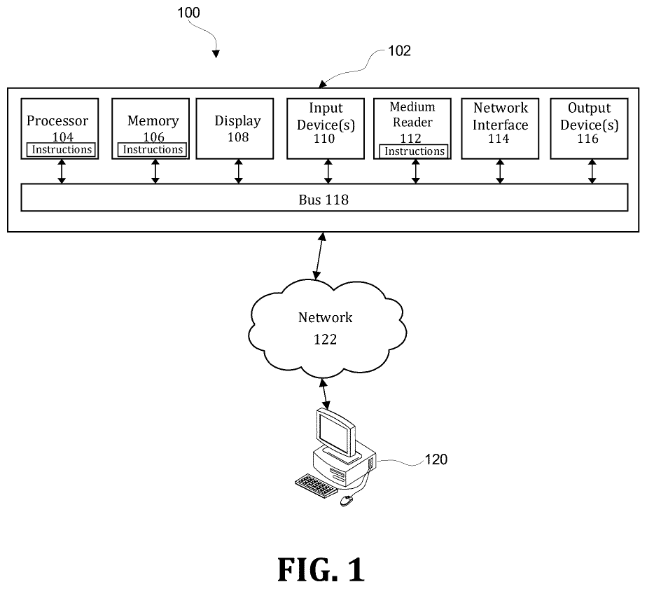

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a virtual desktop computer, a tablet computer, a set-top box, a personal digital assistant, a mobile device, a palmtop computer, a laptop computer, a desktop computer, a communications device, a wireless smart phone, a personal trusted device, a wearable device, a global positioning system (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disc read only memory (CD-ROM), digital versatile disc (DVD), floppy disk, blu-ray disc, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other type of display, examples of which are well known to persons skilled in the art.

The computer system 102 may also include at least one input device 110, such as a keyboard, a touch-sensitive input screen or pad, a speech input, a mouse, a remote-control device having a wireless keypad, a microphone coupled to a speech recognition engine, a camera such as a video camera or still camera, a cursor control device, a GPS device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software, or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for providing a management framework that facilitates improvements in distributed event processing by utilizing a unique multiple-consumers/multiple-producers design.

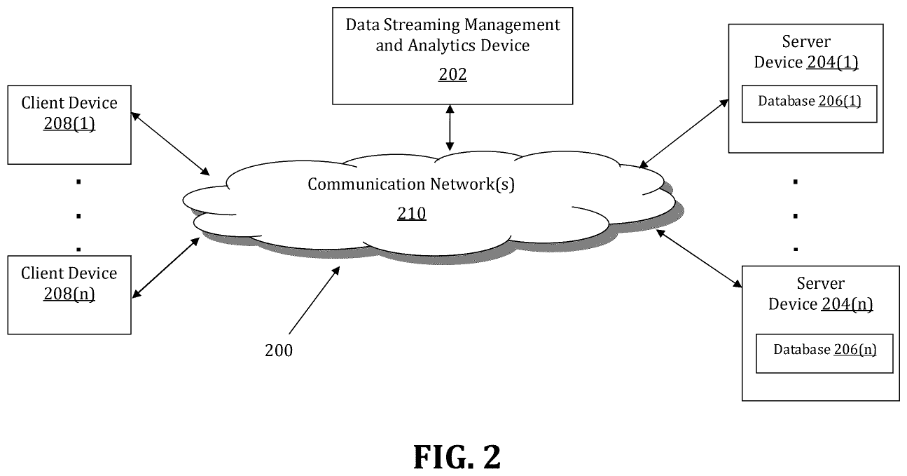

Referring to FIG. 2, a schematic of an exemplary network environment 200 for implementing a method for providing a management framework that facilitates improvements in distributed event processing by utilizing a unique multiple-consumers/multiple-producers design is illustrated. In an exemplary embodiment, the method is executable on any networked computer platform, such as, for example, a personal computer (PC).

The method for providing a management framework that facilitates improvements in distributed event processing by utilizing a unique multiple-consumers/multiple-producers design may be implemented by a Data Streaming Management and Analytics (DSMA) device 202. The DSMA device 202 may be the same or similar to the computer system 102 as described with respect to FIG. 1. The DSMA device 202 may store one or more applications that can include executable instructions that, when executed by the DSMA device 202, cause the DSMA device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the DSMA device 202 itself, may be located in virtual server(s) running in a cloud-based computing environment rather than being tied to one or more specific physical network computing devices. Also, the application(s) may be running in one or more virtual machines (VMs) executing on the DSMA device 202. Additionally, in one or more embodiments of this technology, virtual machine(s) running on the DSMA device 202 may be managed or supervised by a hypervisor.

In the network environment 200 of FIG. 2, the DSMA device 202 is coupled to a plurality of server devices 204(1)-204(n) that hosts a plurality of databases 206(1)-206(n), and also to a plurality of client devices 208(1)-208(n) via communication network(s) 210. A communication interface of the DSMA device 202, such as the network interface 114 of the computer system 102 of FIG. 1, operatively couples and communicates between the DSMA device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the DSMA device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and DSMA devices that efficiently implement a method for providing a management framework that facilitates improvements in distributed event processing by utilizing a unique multiple-consumers/multiple-producers design.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The DSMA device 202 may be a standalone device or integrated with one or more other devices or apparatuses, such as one or more of the server devices 204(1)-204(n), for example. In one particular example, the DSMA device 202 may include or be hosted by one of the server devices 204(1)-204(n), and other arrangements are also possible. Moreover, one or more of the devices of the DSMA device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the DSMA device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store data that relates to event messages, data fetch size configurations, data polling configurations, consumer threads, blocking queues, auxiliary consumer threads, predefined logics, producer buffers, selection logics, load balancers, agreements, and shared collections.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a controller/agent approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the DSMA device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the DSMA device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the DSMA device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the DSMA device 202, the server devices 204(1)-204(n), or the client devices 208(1)-208(n), for example, may be configured to operate as virtual instances on the same physical machine. In other words, one or more of the DSMA device 202, the server devices 204(1)-204(n), or the client devices 208(1)-208(n) may operate on the same physical device rather than as separate devices communicating through communication network(s) 210. Additionally, there may be more or fewer DSMA devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication, also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

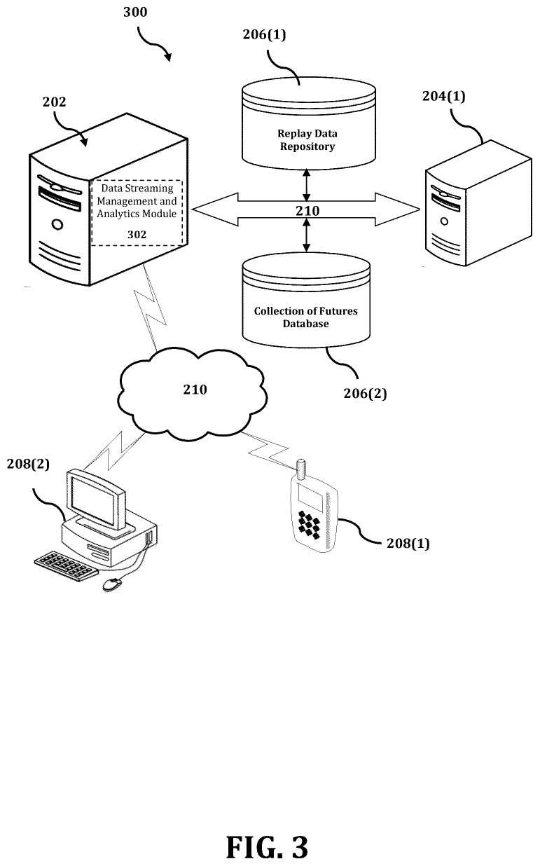

The DSMA device 202 is described and shown in FIG. 3 as including a data streaming management and analytics module 302, although it may include other rules, policies, modules, databases, or applications, for example. As will be described below, the data streaming management and analytics module 302 is configured to implement a method for providing a management framework that facilitates improvements in distributed event processing by utilizing a unique multiple-consumers/multiple-producers design.

An exemplary process 300 for implementing a mechanism for providing a management framework that facilitates improvements in distributed event processing by utilizing a unique multiple-consumers/multiple-producers design by utilizing the network environment of FIG. 2 is shown as being executed in FIG. 3. Specifically, a first client device 208(1) and a second client device 208(2) are illustrated as being in communication with DSMA device 202. In this regard, the first client device 208(1) and the second client device 208(2) may be “clients” of the DSMA device 202 and are described herein as such. Nevertheless, it is to be known and understood that the first client device 208(1) and/or the second client device 208(2) need not necessarily be “clients” of the DSMA device 202, or any entity described in association therewith herein. Any additional or alternative relationship may exist between either or both of the first client device 208(1) and the second client device 208(2) and the DSMA device 202, or no relationship may exist.

Further, DSMA device 202 is illustrated as being able to access a replay data repository 206(1) and a collection of Futures database 206(2). The data streaming management and analytics module 302 may be configured to access these databases for implementing a method for providing a management framework that facilitates improvements in distributed event processing by utilizing a unique multiple-consumers/multiple-producers design.

The first client device 208(1) may be, for example, a smart phone. Of course, the first client device 208(1) may be any additional device described herein. The second client device 208(2) may be, for example, a PC. Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the DSMA device 202 via broadband or cellular communication. Of course, these embodiments are merely exemplary and are not limiting or exhaustive.

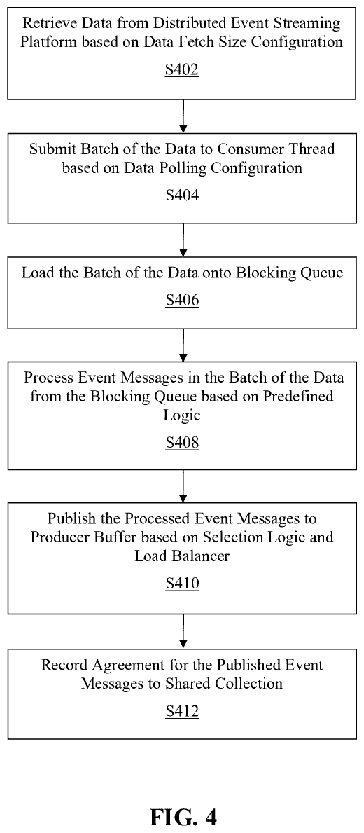

Upon being started, the data streaming management and analytics module 302 executes a process for providing a management framework that facilitates improvements in distributed event processing by utilizing a unique multiple-consumers/multiple-producers design. An exemplary process for providing a management framework that facilitates improvements in distributed event processing by utilizing a unique multiple-consumers/multiple-producers design is generally indicated at flowchart 400 in FIG. 4.

In the process 400 of FIG. 4, at step S402, data may be retrieved from a distributed event streaming platform based on a data fetch size configuration. The data may be retrieved from the distributed event streaming platform via a client such as, for example, a streaming platform client. In an exemplary embodiment, the data may include event messages. The event messages may relate to event records that provide information about an occurred event. The event messages may include the information in any combination of alphabetic, numeric, and symbolic characters. The event messages may be configured consistent with requirements of the distributed event streaming platform.

In another exemplary embodiment, the distributed event streaming platform may relate to a distributed event store and stream processing platform. The distributed event streaming platform may provide a unified, high-throughput, low-latency platform for handling real-time data feeds. The distributed event streaming platform may provide high-performance data pipelines, streaming analytics, data integration, and mission-critical applications. The distributed event streaming platform may include various clients such as, for example, programs that are capable of obtaining a service provided by the distributed event streaming platform.

In another exemplary embodiment, the data fetch size configuration may include a maximum fetch bytes value that is determined based on event message size to minimize a waiting threshold value for a batch processor. The maximum fetch bytes value may relate to a quantity of data such as, for example, an amount of bytes. The maximum fetch bytes value may be determined based on message size such that a batch processor does not have to wait for the next batch. Additionally, the maximum fetch bytes value may be determined to optimize memory utilization. The waiting threshold value may relate to an amount of time.

At step S404, a batch of the data may be submitted to a consumer thread based on a data polling configuration. The batch of the data may be submitted via the client. In an exemplary embodiment, a batch of event messages may be identified and combined from the retrieved data. The batch of event messages may include any combination of event messages in the retrieved data.

In another exemplary embodiment, the consumer thread may relate to a programming structure and/or computing process formed by linking a number of separate elements and/or subroutines. Each of the tasks in the computing process may be performed concurrently and/or sequentially. In another exemplary embodiment, the data polling configuration may include a maximum size value for the batch of the data. The maximum size value may be predetermined to optimize efficiency.

At step S406, the batch of the data may be loaded onto a data structure that enables coordination of a plurality of processing threads. The batch of the data may be loaded via the consumer thread. In an exemplary embodiment, the data structure may include a blocking queue. The blocking queue may relate to a queue that supports process flow control by blocking processes based on whether the queue is full or empty. The blocking queue may include at least one from among an unbounded queue and a bounded queue. The unbounded queue may grow almost indefinitely while the bounded queue has predefined maximum capacity.

In another exemplary embodiment, one from among a plurality of the data structure may be assigned to each of the auxiliary consumer thread to preserve a processing order from an upstream topic. For example, to preserve a processing order, a blocking queue may be assigned to each of the asynchronous processing threads.

In another exemplary embodiment, to facilitate the loading of the batch, the data structure may be monitored to determine whether the data structure is empty. The data structure may be monitored via the consumer thread. For example, the consumer thread may wait for the blocking queue to be empty.

Then, the agreement may be collected for each of the published event messages in the batch of the data. The agreements may be collected via the consumer thread based on a predetermined criterion when the data structure is empty. For example, when the blocking queue is empty, the consumer thread may wait to collect all agreements until the predetermined criterion is satisfied. The criterion may include at least one from among a predefined time value and a quantity value that corresponds to a number of the agreement that is equivalent in size to the batch of the data.

At step S408, each of the event messages in the batch of the data from the data structure may be processed based on predefined logic. The event messages from the data structure may be processed via auxiliary consumer threads. In an exemplary embodiment, each of the auxiliary consumer threads may be predefined to asynchronously process each of the event messages in the batch of the data from the data structure. The event messages may be processed according to predefined logic such as, for example, a business logic.

In another exemplary embodiment, to facilitate the processing of each of the event messages in the batch of the data from the data structure, a determination may be made that the event messages in the batch are available in the data structure. Each of the event messages in the batch may be determined via a corresponding auxiliary consumer thread. For example, a predefined asynchronous consumer thread may wait on a blocking queue for messages to arrive.

Then, the available event messages in the batch may be removed from the data structure. The available event messages may be removed from the data structure via the corresponding auxiliary consumer thread. For example, the asynchronous consumer threads may each receive and remove the event messages from the blocking queue.

Finally, the predefined logic may be performed on the removed event messages. The predefined logic may be performed for each of the event messages via the corresponding auxiliary consumer thread. For example, the asynchronous consumer threads may each perform business logic on the event messages.

At step S410, each of the processed event messages in the batch of the data may be published to a producer buffer based on a selection logic. The processed event messages may be published to the producer buffer via the auxiliary consumer thread. In an exemplary embodiment, the producer buffer may include a load balancer. For example, the asynchronous consumer thread may publish the event messages on the load balanced producer buffers based on a random selection logic.

At step S412, an agreement may be recorded for each of the published event messages in the batch of the data. The agreement may be recorded to a shared collection via the auxiliary consumer thread. In an exemplary embodiment, the agreement for each of the published event messages in the batch of the data may include a future callback such as, for example, a Future function that is invoked when an asynchronously sent record has been acknowledged as received. The agreement may be used interchangeably with the Future function in the present disclosure.

In another exemplary embodiment, each of the published event messages in the batch of the data may be flushed to an event streaming broker based on a predetermined setting. The published event messages may be flushed to the event streaming broker via the producer buffer. For example, each of the producer buffers may flush the data to a distributed event streaming broker based on at least one from among a producer batch size setting and a producer linger time setting. This process may also mark the agreements as done for every event message published to the distributed event streaming broker. Alternatively, this process may mark the event messages as exceptions when there is a failure in the publishing process.

Then, a completion status for each of the published event messages in the batch of the data may be determined based on the agreement. The completion status for the event messages may be determined via the consumer thread. For example, the consumer thread may iterate through agreements when the consumer thread is out of the wait cycle. The consumer thread may also wait for individual agreement completions and record any agreement exceptions.

Finally, the batch of the data may be committed to the client based on the completion status to enable the polling of a new batch of the data. The batch of the data may be committed to the client via the consumer thread. For example, the consumer thread may commit the current batch and polls for the next batch. The event messages may be journaled to a replay store using a journal consumer group. The replay store may be used when processing replays are required.

In another exemplary embodiment, consistent with present disclosures, the provided framework may be enhanced to preserve the order of processing as received from upstream topics. The enhancement may relate to the assigning of one from among a plurality of the data structure to each of the auxiliary consumer thread to preserve a processing order from an upstream topic. For example, the design of the enhanced framework may include the assignment of a data structure such as a blocking queue to each of the asynchronous processing threads. The design may utilize metadata offset and partition number from the event messages. Every partition number may be map to single blocking queue and event messages may be published to the blocking queue in the order of the offset number.

In another exemplary embodiment, since each asynchronous thread processes the event messages only from a single partition, the provided design may ensure that message processing is in the same order as received from the upstream topic. The provided design may have more memory footprint but is favorable for applications requiring processing order.

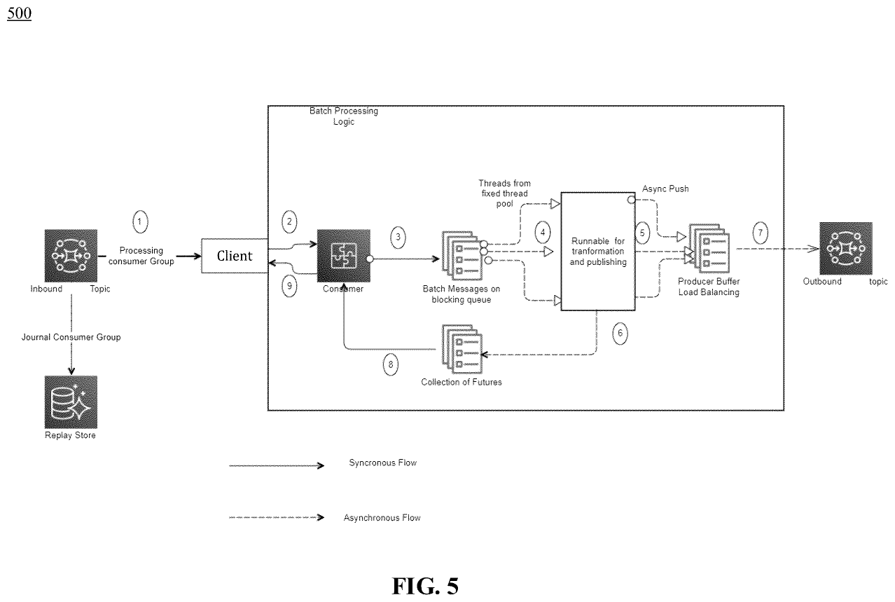

FIG. 5 is a flow diagram of an exemplary process for implementing a method for providing a management framework that facilitates improvements in distributed event processing by utilizing a unique multiple-consumers/multiple-producers design. In FIG. 5, a framework to boost performance with minimum infrastructure cost escalation is disclosed. The framework may boost performance while continuing to leverage available distributed event streaming platform features.

For example, acceptance criteria for the framework may include: full utilization of network bandwidth while reading and writing; full utilization of available compute power; designed to support low latency for a range of transaction load; continued distributed event streaming platform support for abrupt crash survival with zero message loss; continued distributed event streaming platform support for guaranteed processing; zero duplicates caused by the framework; individual message loss due to run time issues does not block whole batch; and replay feasible for failed messages.

As illustrated in FIG. 5, at step 1, a client such as, for example, a processing consumer group may fetch data from a distributed event streaming platform based on data fetch size configurations. The data fetch size configurations may include a value that has been determined based on message size so that a corresponding batch processor does not have to wait for subsequent batches. Additionally, the value may be determined to optimize memory utilization. At step 2, the client may submit a batch of the data to a consumer thread. The size of the batch may be determined based on a data polling configuration.

At step 3, the consumer thread may load the batch onto a data structure such as, for example, a blocking queue implementation. The consumer thread may then wait for the blocking queue to be empty. Once empty, the consumer thread may wait until a predefined time and/or a number of agreements such as, for example, a number of Futures to be equal to the batch size to collect all of the available agreements. The consumer thread may wait until the earlier of the predefined time or the number of agreements.

At step 4, auxiliary consumer threads such as, for example, predefined asynchronous consumer threads may monitor the blocking queue to determine whether the event messages have arrived. When the event messages have arrived in the blocking queue, each of the asynchronous consumer threads may receive and remove the event messages from the blocking queue. Then, the asynchronous consumer threads may perform logics such as, for example, predetermined business logic on the removed event messages.

At step 5, the asynchronous consumer threads may publish the processed event massages on the load balanced producer buffers based on a selection logic such as, for example, a random selection logic. At step 6, the asynchronous consumer threads may record the resulting agreements in the shared collection. At step 7, each of the producer buffers may flush the data to a distributed event streaming broker based on at least one from among a producer batch size setting and a producer linger time setting. This step may also mark the agreements as done for every event message published to the distributed event streaming broker. Alternatively, this step may mark the event messages as exceptions when there is a failure in the publishing process.

At step 8, the consumer thread may iterate through agreements when the consumer thread is out of the wait cycle. The consumer thread may also wait for individual agreement completions and record any agreement exceptions. Then, at step 9, the consumer thread may commit the current batch and polls for the next batch. The event messages may be journaled to a replay store using a journal consumer group. The replay store may be used when processing replays are required.

In another exemplary embodiment, full utilization of network bandwidth while reading and writing data may be implemented to optimize inputs and outputs. As stated in steps 1 and 2 of the disclosed framework, provided implementations may read data in batches, which helps lessen network trips to fetch data versus reading one message at a time. Likewise, as stated in step 7 of the disclosed framework, provided implementations ensure that data is produced separately by multiple producers. Thus, fewer network trips are required versus producing similar data with a single producer.

In another exemplary embodiment, computing power may be optimized. Provided implementations in steps 1 and 2 may keep the data prefetched and deliver batches to consumer functions. As such, the consumer functions may not use CPU cycles waiting for data. The consumer functions may consistently have work ready on the plate as long as data streaming is on. As in step 4, single partition data may be processed in parallel by asynchronous thread pool. This processing supports full utilization of available CPU cycles.

Further, as stated in step 8, only the consumer thread may be using CPU cycles waiting for agreements to be completed while asynchronous threads just record the agreements. Most of the wait period may be in parallel with asynchronous message processing, which implies that by the time collection is ready with all agreements, most of the agreements are completed. These implementations may result in minimal CPU cycle usage for waits.

In another exemplary embodiment, as applied to producer load balancing, The disclosed implementations may use principles of scalability when it comes to load balancing. The implementations may further help in tuning applications such that the tuning gives low latency for both low and high load. Each producer may be configured to cater to smaller batching of messages. However, for example, five producers together may cater to larger batching of messages. Every asynchronous thread may randomly push data to producers. Consistent with step 7, these producers may produce data separately. As such, regardless of low or high load, data will get flushed within a maximum time as provided for by a producer linger time setting. This flushing process may prevent longer waiting times for low load when producer was configured for high load, and vice versa.

In another exemplary embodiment, the combination of synchronous and asynchronous processes may provide additional improvements. Synchronous consumption (i.e., consuming next batch only after committing previous) ensures zero message loss on abrupt crashes and guarantees processing. However, synchronous publishing may degrade throughput. In contrast, asynchronous publishing ensures higher throughput. However, asynchronous consumption may cause message loss on abrupt crashes.

As such, the disclosed implementation may achieve the best path forward by combining synchronous consumption with asynchronous publishing. Step 8 ensures that next batch may be read only after previous batch is completed and committed. Steps 5 and 6 may achieve asynchronous publishing. This combination may be achieved by decoupling consumption and publishing using blocking queues. Processing may be forked at blocking queue but joined again in consumer thread at scanning agreements.

In another exemplary embodiment, the disclosed implementations may ensure zero duplicates. As in steps 8 and 9, zero duplicates may be ensured with this design since consumer thread ensures both commit and fetch operations are performed sequentially.

In another exemplary embodiment, the disclosed implementations may incorporate improved error handling. As in steps 3 and 8, the consumer thread may wait for a predefined time to collect all futures such that size is equal to a number of messages in the batch. In either a first case of fewer agreements than messages or a second case when the agreement has exception, the consumer thread does not block a whole batch but rather reports individual messages facing failures. Disclosed implementations may also ensure that identifiers are consistently maintained across messages and agreements.

In another exemplary embodiment, the disclosed implementations may incorporate improved replays. A journal consumer group may record event messages in a replay store. This recording ensures that journaling flow does not throttle processing flow, which is throughput critical. Processing consumers may ensure that a batch is committed post pre-defined time regardless of whether there are fewer agreements than messages or whether the agreement has exceptions. As previously disclosed in the error handling step, message identifiers with missing agreements may be maintained in a data store. These messages identifiers in combination with replays that are stored may be used for replay needs.

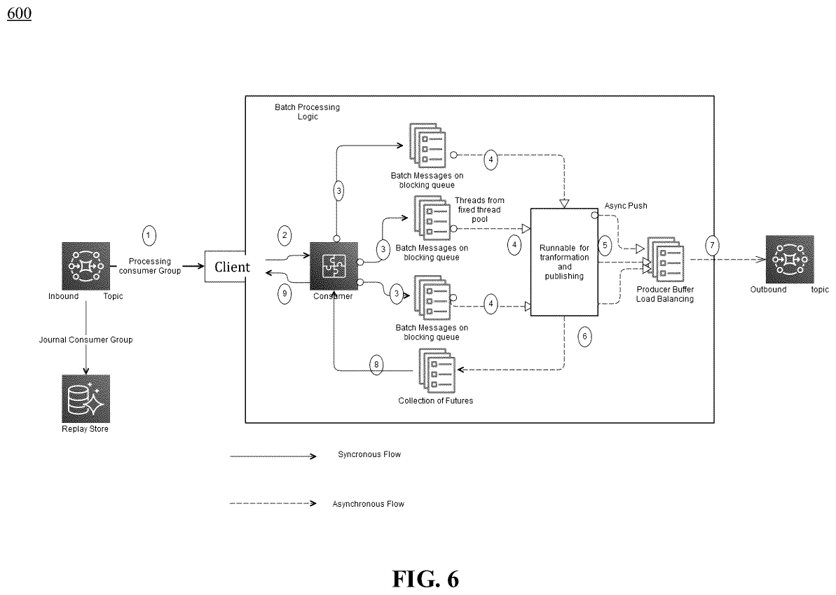

FIG. 6 is a flow diagram of an exemplary order processing preservation process for implementing a method for providing a management framework that facilitates improvements in distributed event processing by utilizing a unique multiple-consumers/multiple-producers design. In FIG. 6, consistent with present disclosures, an enhanced framework may be provided to preserve the order of processing as received from upstream topics.

As illustrated in FIG. 6, the enhancement may relate to the assigning of one from among a plurality of the data structure to each of the auxiliary consumer thread to preserve a processing order from an upstream topic. For example, the design of the enhanced framework may include the assignment of a data structure such as a blocking queue to each of the asynchronous processing threads. The design may utilize metadata offset and partition number from the event messages. Every partition number may be map to single blocking queue and event messages may be published to the blocking queue in the order of the offset number.

Since each asynchronous thread processes the event messages only from a single partition, the provided design may ensure that message processing is in the same order as received from the upstream topic. The provided design may have more memory footprint but is favorable for applications requiring processing order.

Accordingly, with this technology, an optimized process for providing a management framework that facilitates improvements in distributed event processing by utilizing a unique multiple-consumers/multiple-producers design is disclosed.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for providing a management framework for distributed event processing, the method being implemented by at least one processor, the method comprising:
retrieving, by the at least one processor via a client, data from a distributed event streaming platform based on a data fetch size configuration, the data including at least one event message;
submitting, by the at least one processor via the client, a batch of the data to a consumer thread based on a data polling configuration;
loading, by the at least one processor via the consumer thread, the batch of the data onto a data structure that enables coordination of a plurality of processing threads, the data structure including a blocking queue;
processing, by the at least one processor via at least one auxiliary consumer thread, each of the at least one event message in the batch of the data from the data structure based on at least one predefined logic;
publishing, by the at least one processor via the at least one auxiliary consumer thread, each of the processed at least one event message in the batch of the data to a producer buffer based on a selection logic, the producer buffer including a load balancer; and
recording, by the at least one processor via the at least one auxiliary consumer thread, an agreement for each of the published at least one event message in the batch of the data to a shared collection.

2. The method of claim 1, further comprising:
flushing, by the at least one processor via the producer buffer, each of the published at least one event message in the batch of the data to an event streaming broker based on at least one setting;
determining, by the at least one processor via the consumer thread, a completion status for each of the published at least one event message in the batch of the data based on the agreement; and
committing, by the at least one processor via the consumer thread, the batch of the data to the client based on the completion status and polling a new batch of the data.

3. The method of claim 1, wherein the data fetch size configuration includes a maximum fetch bytes value that is determined based on event message size to minimize a waiting threshold value for a batch processor, the waiting threshold value relating to an amount of time.

4. The method of claim 1, wherein the data polling configuration includes a maximum size value for the batch of the data.

5. The method of claim 1, wherein the loading of the batch of the data onto the data structure further comprises:
monitoring, by the at least one processor via the consumer thread, the data structure to determine whether the data structure is empty; and
collecting, by the at least one processor via the consumer thread, the agreement for each of the published at least one event message in the batch of the data when the data structure is empty based on a criterion,
wherein the criterion includes at least one from among a predefined time value and a quantity value that corresponds to a number of the agreement that is equivalent in size to the batch of the data.

6. The method of claim 1, wherein each of the at least one auxiliary consumer thread is predefined to asynchronously process each of the at least one event message in the batch of the data from the data structure.

7. The method of claim 1, wherein the processing of each of the at least one event message in the batch of the data from the data structure further comprises:
determining, by the at least one processor via each of the at least one auxiliary consumer thread, that the corresponding at least one event message in the batch of the data is available in the data structure;
removing, by the at least one processor via each of the at least one auxiliary consumer thread, the corresponding at least one event message in the batch of the data from the data structure; and
performing, by the at least one processor via each of the at least one auxiliary consumer thread, the corresponding at least one predefined logic on the removed corresponding at least one event message.

8. The method of claim 1, wherein the agreement for each of the published at least one event message in the batch of the data includes a future callback that is invoked when an asynchronously sent record has been acknowledged as received.

9. The method of claim 1, wherein one from among a plurality of the data structure is assigned to each of the at least one auxiliary consumer thread to preserve a processing order from an upstream topic.

10. A computing device configured to implement an execution of a method for providing a management framework for distributed event processing, the computing device comprising:
a processor;
a memory; and
a communication interface coupled to each of the processor and the memory, wherein the processor is configured to:
retrieve, via a client, data from a distributed event streaming platform based on a data fetch size configuration, the data including at least one event message;
submit, via the client, a batch of the data to a consumer thread based on a data polling configuration;
load, via the consumer thread, the batch of the data onto a data structure that enables coordination of a plurality of processing threads, the data structure including a blocking queue;
process, via at least one auxiliary consumer thread, each of the at least one event message in the batch of the data from the data structure based on at least one predefined logic;
publish, via the at least one auxiliary consumer thread, each of the processed at least one event message in the batch of the data to a producer buffer based on a selection logic, the producer buffer including a load balancer; and
record, via the at least one auxiliary consumer thread, an agreement for each of the published at least one event message in the batch of the data to a shared collection.

11. The computing device of claim 10, wherein the processor is further configured to:
flush, via the producer buffer, each of the published at least one event message in the batch of the data to an event streaming broker based on at least one setting;
determine, via the consumer thread, a completion status for each of the published at least one event message in the batch of the data based on the agreement; and
commit, via the consumer thread, the batch of the data to the client based on the completion status and polling a new batch of the data.

12. The computing device of claim 10, wherein the data fetch size configuration includes a maximum fetch bytes value that is determined based on event message size to minimize a waiting threshold value for a batch processor, the waiting threshold value relating to an amount of time.

13. The computing device of claim 10, wherein the data polling configuration includes a maximum size value for the batch of the data.

14. The computing device of claim 10, wherein, to load the batch of the data onto the data structure, the processor is further configured to:
monitor, via the consumer thread, the data structure to determine whether the data structure is empty; and
collect, via the consumer thread, the agreement for each of the published at least one event message in the batch of the data when the data structure is empty based on a criterion,
wherein the criterion includes at least one from among a predefined time value and a quantity value that corresponds to a number of the agreement that is equivalent in size to the batch of the data.

15. The computing device of claim 10, wherein the processor is further configured to predefine each of the at least one auxiliary consumer thread to asynchronously process each of the at least one event message in the batch of the data from the data structure.

16. The computing device of claim 10, wherein, to process each of the at least one event message in the batch of the data from the data structure, the processor is further configured to:
determine, via each of the at least one auxiliary consumer thread, that the corresponding at least one event message in the batch of the data is available in the data structure;
remove, via each of the at least one auxiliary consumer thread, the corresponding at least one event message in the batch of the data from the data structure; and
perform, via each of the at least one auxiliary consumer thread, the corresponding at least one predefined logic on the removed corresponding at least one event message.

17. The computing device of claim 10, wherein the agreement for each of the published at least one event message in the batch of the data includes a future callback that is invoked when an asynchronously sent record has been acknowledged as received.

18. The computing device of claim 10, wherein the processor is further configured to assign one from among a plurality of the data structure to each of the at least one auxiliary consumer thread to preserve a processing order from an upstream topic.

19. A non-transitory computer readable storage medium storing instructions for providing a management framework for distributed event processing, the storage medium comprising executable code which, when executed by a processor, causes the processor to:
retrieve, via a client, data from a distributed event streaming platform based on a data fetch size configuration, the data including at least one event message;
submit, via the client, a batch of the data to a consumer thread based on a data polling configuration;
load, via the consumer thread, the batch of the data onto a data structure that enables coordination of a plurality of processing threads, the data structure including a blocking queue;
process, via at least one auxiliary consumer thread, each of the at least one event message in the batch of the data from the data structure based on at least one predefined logic;
publish, via the at least one auxiliary consumer thread, each of the processed at least one event message in the batch of the data to a producer buffer based on a selection logic, the producer buffer including a load balancer; and
record, via the at least one auxiliary consumer thread, an agreement for each of the published at least one event message in the batch of the data to a shared collection.

20. The storage medium of claim 19, wherein, when executed by the processor, the executable code further causes the processor to:
flush, via the producer buffer, each of the published at least one event message in the batch of the data to an event streaming broker based on at least one setting;
determine, via the consumer thread, a completion status for each of the published at least one event message in the batch of the data based on the agreement; and
commit, via the consumer thread, the batch of the data to the client based on the completion status and polling a new batch of the data.
